(19) United States
(12) Patent Application Publication
(10) Pub. No.: US 2023/0046905 A1
(43) Pub. Date: Feb. 16, 2023

(54) Generator Drive System on Engine Drive Compressor Applications

(71) Applicant: EADS Cooling Solutions LLC, Houston, TX (US)

(72) Inventor: Michael Garner, Houston, TX (US)

(21) Appl. No.: 17/403,085

(22) Filed: Aug. 16, 2021

(51) Int. Cl. F02B 63/04; F02B 63/06; F01P 3/20

(52) U.S. Cl. CPC F02B 63/044; F02B 63/06; F01P 3/20; F02B 2043/103

(57) ABSTRACT

Aspects of the disclosure present a cooler driven by an engine turning a generator wherein the engine and the cooler are not linked by a direct drive shaft.

### CROSS-REFERENCE TO RELATED APPLICATIONS

None

### FIELD OF THE DISCLOSURE

Aspects of the disclosure relate systems and method used to drive electrical generators. More specifically, aspects of the disclosure relate to a generator driving system and method that is used in conjunction with coolers and internal combustion engines.

### BACKGROUND

Conventional apparatus used in the process of compressing gas are known. These conventional apparatus are used in conjunction with various equipment in areas that are often remote and do not have grid supplied power. In a typical installation, the internal combustion engine is connected to the cooler through a direct drive system, usually a V-belt. In other embodiments, the V-belt is replaced by a more robust connection, such as a direct drive shaft. As the engine is directly connected to the cooler, a change in engine speed directly correlates to a change in operating parameters for the cooler. Thus, if the cooler is desired to be run at full speed, then the engine must be run at full speed.

In these conventional apparatus, the internal combustion engine is also connected to a compressor, such as a gas compressor. The compressor may compress gas at a specified rate and quantity to meet the needs of an industrial process. While these typical conventional apparatus have a simplicity of design, various drawbacks are present that hampers their overall use. First, the hard or direct drive connections between the engine and cooler provide for little variability in speed between the cooler and the internal combustion engine. Thus, in times where it is not desired to have much cooling, the engine must throttle down, thereby effecting compressor operation. Such conventional apparatus must be run at high speeds, presenting a fuel concern as well as operating cost concern for these conventional apparatus. Moreover, as environmentally friendly operations are desired to be achieved, using large amounts of hydrocarbons to power the internal combustion engine are also a significant drawback.

There is a need to provide apparatus and methods that easier to operate than conventional apparatus and methods thereby providing flexibility in operations, especially in areas where grid power may be limited.

There is a further need to provide apparatus and methods that do not have the environmental concerns discussed above, wherein hydrocarbons used for powering the internal combustion engine are limited in use.

There is a still further need to reduce economic costs associated with operations and apparatus for gas compression and cooling described above with conventional apparatus and methods.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method of operating a generator drive system used in compressor applications is disclosed. The method may comprise operating an internal combustion engine coupled to a compressor. The method may also comprise producing electrical power from a generator coupled to the internal combustion engine and operating a variable frequency drive connected to the generator. The method may also provide driving a cooler connected to the variable frequency drive, while the internal combustion engine provides a motive operating force to a fluid compressor.

In another embodiment, a method of operating a generator drive system used in compressor applications is disclosed. The method may include operating an internal combustion engine coupled to a compressor: producing electrical power from a generator coupled to the internal combustion engine; and driving a cooler connected to the generator,

In another example embodiment, a non-transitory computer readable media containing instructions is disclosed wherein the instructions are configured to perform a method comprising operating an internal combustion engine, producing electrical power from a generator coupled to the internal combustion engine, operating a variable frequency drive connected to the generator and driving a cooler connected to the variable frequency drive,

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is a diagram of a conventional method for driving coolers on engine driven compression packages.

FIG. 2 is a plan diagram of an arrangement used for driving a generator through an engine drive compressor application, while utilizing a variable frequency drive.

FIG. 3 is a method of operation for the plan diagram of FIG. 2.

FIG. 4 is a computer apparatus used in performing methods and controlling apparatus for the operations of FIG. 1.

FIG. 5 is a second plan diagram of an arrangement used for driving a generator through an engine drive compressor application.

FIG. 6 is a method of operation for the plan diagram of FIG. 5.

FIG. 7 is a side elevational view of a generator used in one example embodiment of the disclosure.

FIG. 8 is an end elevational view of the generator of FIG. 7.

FIG. 9 is a side cross-sectional view of the generator of FIG. 7 installed within an enclosure.

FIG. 10 is an isometric view of the installation of FIG. 9.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims, except where explicitly recited in a claim. Likewise, reference to “the disclosure” shall not be construed as a generalization of inventive subject matter disclosed herein and shall not be considered to be an element or limitation of the claims, except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

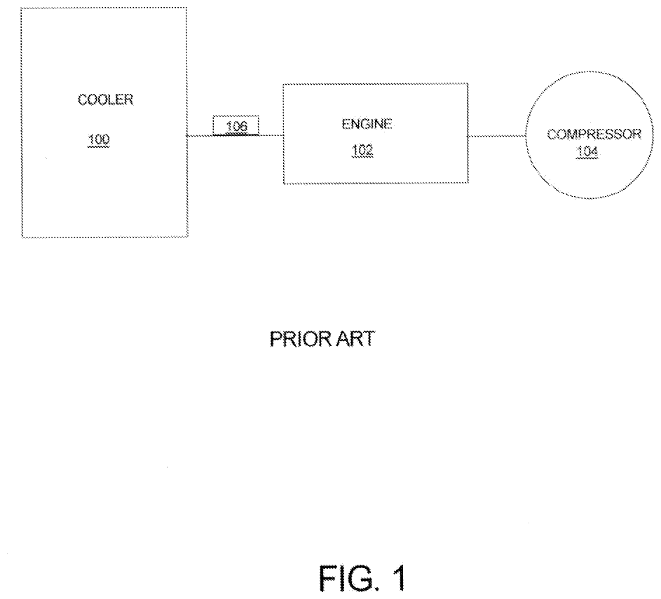

Currently, compression packages (consisting of an engine driving a compressor and a cooler) are located in areas where there is not an abundance of reliable grid power. Coolers are driven through some sort of transmission (direct, V-belt, or other) from the engine. As illustrated in FIG. 1, a cooler is connected to other equipment. In this prior art configuration, the cooler speed is always dependent upon an engine speed. As the engine speeds up, the cooler speeds up. As the engine speed decreases, so does the cooler speed. This direct linking of speeds of the cooler and the engine does not allow an operator to independently adjust fan speed to control cooling based on temperature overload. The ability to lower fan speed (and therefore airflow) during periods of low demand can provide a great power savings to the customer over time. This power savings translates to lower fuel consumption by the engine to drive the cooler, thereby reducing carbon emissions during periods of low demand (as seen during evenings and/or cooler days). In addition, lowering the fan speed (and airflow) can provide a reduction in noise output, lowering the impact on the environment. In FIG. 1, the cooler 100 is directly driven by the engine 102 through a belt 106. In other embodiments, the connection between the engine 102 and the cooler 100 may be a direct shaft drive. A compressor 104 is also connected to the engine 102 for running compressor functions. Compressor functions may be, for example, compressing gases as needed by an industrial or commercial process. The compressor 104 may compress fluids, such as a gas, to volumes and pressures needed by the operator. As direct drive is used between the cooler 100 and the engine 102, slowing of the engine 102 reduces cooling capability in the cooler 100. In some instances, cooling capability of the cooler 100 may be different than full throttle operation of the internal combustion engine 102 coupled to the compressor 104. Therefore, in order to achieve required cooling rates in the cooler 100 as well as compression rates in the compressor 104, the internal combustion engine 102 must be run at higher than wanted rates, thereby consuming more hydrocarbons and being environmentally wasteful.

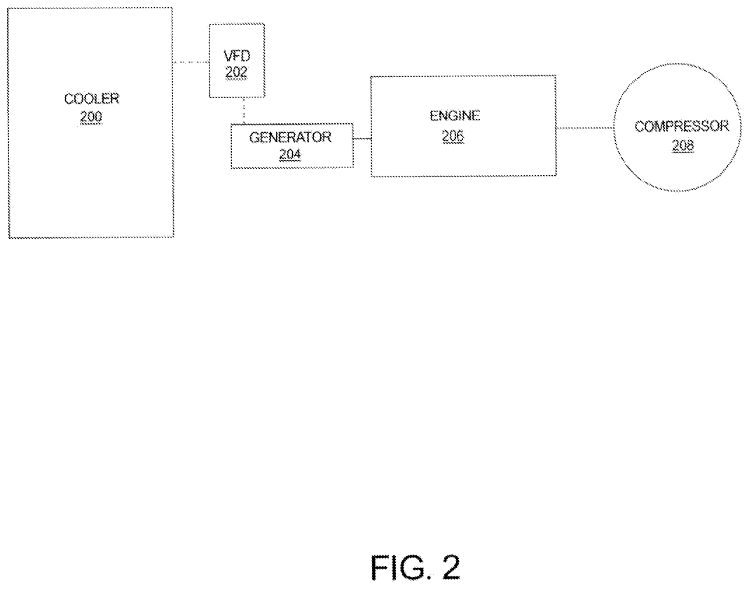

One example arrangement of the disclosure is presented in connection with FIG. 2. The aspects disclosed represent a significant change from conventional apparatus disclosed in FIG. 1. The aspects disclosed provide for flexible connection between a cooler and an internal combustion engine, thereby allowing more independent operation of the cooler and the internal combustion engine. Such embodiments provide an environmental benefit in allowing the cooler to be slowed or run at increased speeds, independent of the speed of an internal combustion engine. Referring to FIG. 2, an internal combustion engine 206 is provided to provide a motive force to a compressor 208. In one embodiment, the internal combustion engine 206 may be a natural gas fed engine. In other embodiments, the internal combustion engine 206 may be a diesel or gasoline powered engine.

The compressor 208 may be used to compress a fluid, such as a gas used for industrial purposes. Such gas may be air, carbon dioxide, nitrogen, natural gas, argon, and hydrogen as non-limiting embodiments. The internal combustion engine 206 is connected to a generator 204 that creates electricity. The electricity may be used, for example, to run the cooler 200. In other embodiments, the generator 204 may be configured to run a variable frequency drive (“VFD”) 202. The VFD 202 allows the cooler 200 to perform in a decoupled fashion from the generator 204, therefore allowing the cooler 200 be run at higher or lower speeds per an operator command. The VFD 202 may be provided with electronics such that the VFD 202 is controllable in real time by operators. Such a connection is a substantial improvement over conventional methods and apparatus.

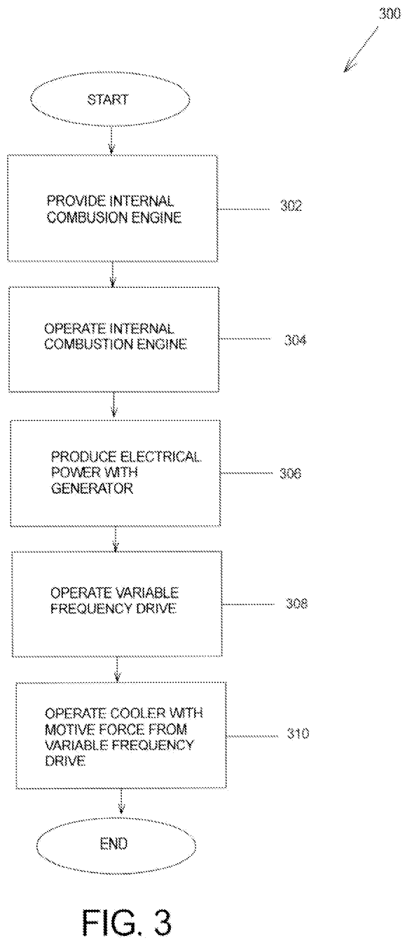

Referring to FIG. 3, a method 300 of operating a generator drive system with an engine on drive compressor application is shown. The method 300 includes providing an internal combustion engine coupled to a compressor at 302. At 304, the internal combustion engine is operated. At 306, a generator connected to the internal combustion engine produces electrical power for use. At 308, a variable frequency drive is operated based upon the produced electrical power from the generator. At 310, the variable frequency drive, connected to a cooler, provides driving force for cooler operation, thereby cooling at least one fluid being processed through the cooler. As will be understood, the use of the variable frequency drive connected to the cooler allows for greater or lower rotational speed of the cooler, thereby allowing

In embodiments, electrical power may be used by the cooler 200 directly from the generator 204. In one embodiment, the variable frequency drive 202 may be omitted. In embodiments where needed, a battery storage system may be used by the cooler 200 for electrical loads that fluctuate during operational times that, at times, may be greater than the electrical output of the generator 204. The battery storage system may be, for example, lithium ion battery packs, in a non-limiting embodiment.

The cooler 200 is used to control the temperature of a flow stream. In one non-limiting embodiment, the cooler 200 is a forced draft ambient air cooled heat exchanger. The cooler 200 may be used to allow for reduction of gas and/or liquid temperatures to allow further processing. For example, cooling may occur from the cooler 200 to allow transfer of fluids along a pipeline within a facility, wherein the pipeline has specifications for temperature and/or pressure. Thus, without the use of a cooler 200, pipeline specifications may be exceeded. The cooler 200 may be sized such that minimal pressure drop is incurred for the fluid being processed. The cooler 200 may be configured with different pressure ratings according to the process needs. In one non-limiting embodiment, the pressure rating may be approximately 1,500 psig. In embodiments, a fan may continuously blow on tube bundles carrying the fluid, thereby providing a cooling effect. The amount of air being transferred by the cooler 200 may be controlled by opening or closing louvers, thereby allowing greater or lesser amounts of flow to through the tubes bundles. In the illustrated embodiment, a single bank of fans is used per louver. Other configurations may allow for banks of fans to be used if ambient conditions necessitate larger amounts of air being drawn inside the cooler 200 to have the desired effect. The cooler 200 used may be a skid mounted unit to allow for rapid movement of the cooler 200 to a facility that is remote. Control of the opening and closing of the louvers may be performed through a logic control arrangement run through a computer, for example. The computer may use sensors, such as a temperature sensor, to allow for accurate prediction of cooling needs when ambient or fluid process temperatures change.

The compressor 208 connected to the engine 206 may be a positive displacement type or a dynamic type compressor. In embodiments, the compressor 208 may be a lobe, screw, liquid ring, scroll, vane, diaphragm, single or double acting unit. Further embodiments are possible wherein a centrifugal or axial dynamic unit may be used. In other embodiments, an auxiliary electric drive motor may also be connected to the compressor 208, the auxiliary electric drive motor connected to the generator 204 and/or a battery system to aid the compressor 208 in processing fluid. As will also be understood, a variable speed coupling may be placed within the system, such as coupling to the engine to a generator to aid in operation.

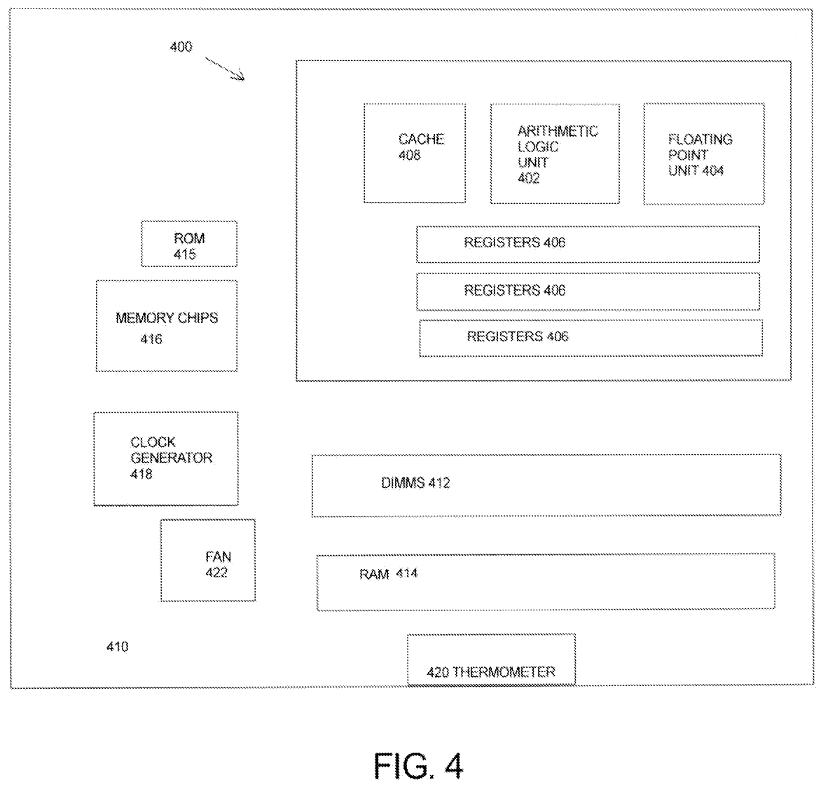

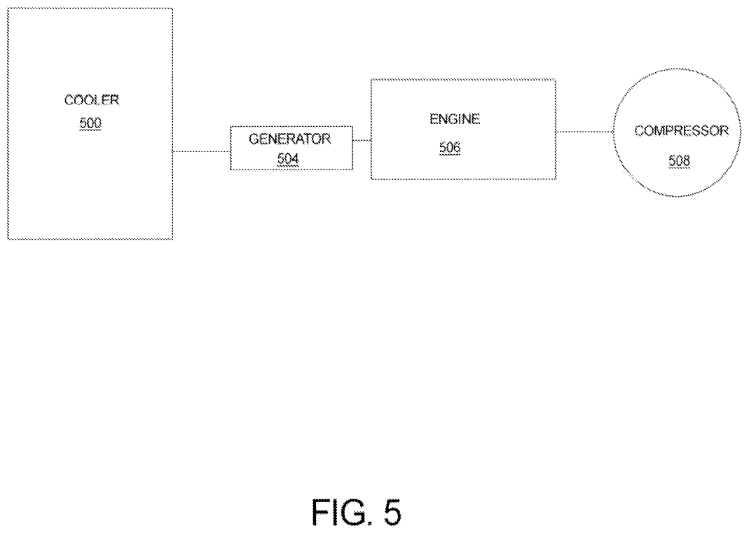

In method embodiments, referring to FIG. 4, apparatus may be used to control the method steps desired to be accomplished. In one embodiment, a computing apparatus used in the control of equipment of FIGS. 2 and 5 is illustrated, in FIG. 4, a processor 400 is provided to perform computational analysis for instructions provided. The instructions provided, code, may be written to achieve the desired goal, and the processor may access the instructions in other embodiments, the instructions may be provided directly to the processor 400. In one embodiment, methods of operation of the coolers, internal combustion engine, compressor, and variable frequency drive may be controlled and monitored by the processor 400 or a series of processors. Connections for sharing data between processors may be provided in instances where more than one processor is used. The instructions for operation may be placed on a disk drive, USB drive, an internet connection or other storage medium. The instructions may be placed on a non-volatile medium so that in case of a power loss, programming will not be lost.

In some embodiments, other components may be substituted for generalized processors. These specifically designed components, known as application specific integrated circuits (“ASICSs”) are specially designed to perform the desired task. The ASICs, when used in embodiments of the disclosure, may be field programmable gate array technology, that allows a user to make variations in computing, as necessary. Thus, the methods described related to the method figures are not specifically held to a precise embodiment, rather alterations of the programming may be achieved through these configurations.

In embodiments, when equipped with a processor 400, the processor 400 may have different components that may be used for completing operations. A non-limiting list of components may include an arithmetic logic unit 402, a floating point unit 404, registers 406 and a single or multiple layer cache 408. The arithmetic logic unit 402 may perform mathematical functions and logic functions. The floating point unit 404 may be configured in differing arrangements that may or may not include a math coprocessor or numeric coprocessor In embodiments, the registers 406 are configured to store data that will be used by the processor 400 during calculations and supply operands to the arithmetic logic unit 402 and store the result of operations. The single or multiple layer caches 408 are provided as a storehouse for data to help in calculation speed by preventing the processor 400 from continually accessing random access memory.

Aspects of the disclosure provide for the use of a single processor 400. Other embodiments of the disclosure allow for the use of more than a single processor. Differing embodiments may use a multi-core processor where different functions are conducted by different processors to aid in calculation speed. In embodiments, when different processors are used, calculations may be performed simultaneously by different processors, a process known as parallel processing.

The processor 400 may be located on a motherboard 410. The motherboard 410 is a printed circuit board that incorporates the processor 400 as well as other components helpful in processing, such as memory modules (“DIMMS”) 412, random access memory 414, read only memory 415, non-volatile memory chips 416, a clock generator 418 that keeps components in synchronization, as well as connectors for connecting other components to the motherboard 410. The motherboard 410 may have different sizes according to the needs of the computer architect. To this end, the different sizes, known as form factors, may vary from sizes from a cellular telephone size to a desktop personal computer size. The motherboard 410 may also provide other services to aid in functioning of the processor, such as cooling capacity, Cooling capacity may include a thermometer 420 and temperature-controlled fan 422 that conveys cooling air over the motherboard 410 to reduce temperature.

Data stored for execution by the processor 400 may be stored in several locations, including the random access memory 414, read only memory, flash memory 424, computer hard disk drives 426, compact disks 428, floppy disks 430 and solid state drives 432. For booting purposes, data may be stored in an integrated chip called an EEPROM, that is accessed during start-up of the processor The data, known as a Basic Input/Output System (“BIOS”), contains, in some example embodiments, an operating system that controls both internal and peripheral components.

Different components may be added to the motherboard or may be connected to the motherboard to enhance processing. Examples of such connections of peripheral components may be video input/output sockets, storage configurations (such as hard disks, solid state disks, or access to cloud based storage), printer communication ports, enhanced video processors, additional random access memory and network cards.

The processor and motherboard may be provided in a discrete form factor, such as personal computer, cellular telephone, tablet, personal digital assistant or other component. The processor and motherboard may be connected to other such similar computing arrangement in networked form. Data may be exchanged between different sections of the network to enhance desired outputs. The network may be a public computing network or may be a secured network where only authorized users or devices may be allowed access.

As will be understood, method steps for completion may be stored in the random access memory, read only memory, flash memory, computer hard disk drives, compact disks, floppy disks and solid state drives.

Referring to FIG. 5, another example arrangement of the disclosure is presented. An internal combustion engine 506 is provided to provide a motive force to a compressor 508 similar to that provided in FIG. 2. The internal combustion engine 506 may be a natural gas fed engine or a diesel or gasoline powered engine.

The compressor 508 is used to compress a fluid, such as a gas used for industrial purposes. Such gas may be air, carbon dioxide, nitrogen, natural gas, argon, and hydrogen as non-limiting embodiments. The internal combustion engine 506 is connected to a generator 604 that creates electricity. The electricity may be used, for example, to run the cooler 500. As with other embodiments, the electricity may be conducted to a battery storage system where electricity is stored for usage by the cooler 500 during times when cooling requirements are minimal. Such a configuration provides efficiency in that energy is stored for times when cooling is more challenging, such as during mid-day operations. In this embodiment, compared to FIG. 2, the apparatus does not include a variable frequency drive.

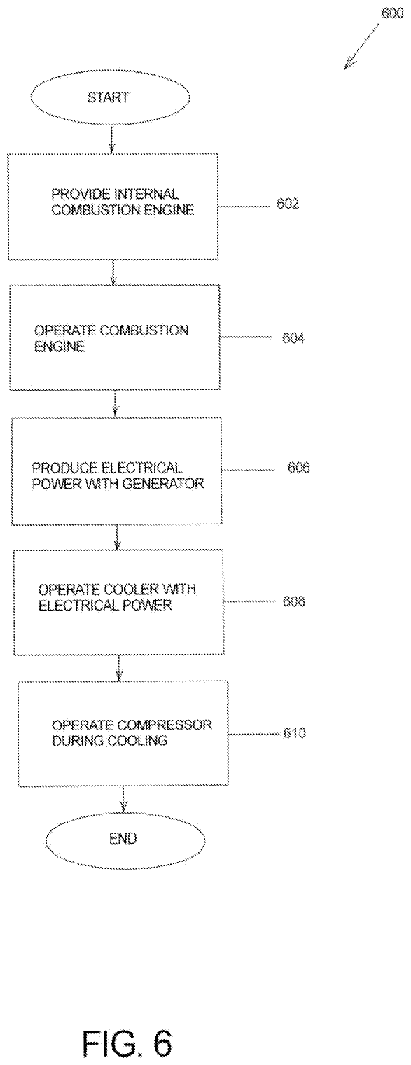

Referring to FIG. 6, a second method 600 for driving a generator is disclosed wherein the system used in that described in FIG. 5. The method 600 includes providing an internal combustion engine coupled to a compressor at 602. At 604, the internal combustion engine is operated. At 606, a generator connected to the internal combustion engine produces electrical power for use. At 608, electrical power from the generator is used to operate a cooler for processing a fluid. At 610, during cooling of the fluid, a compressor is operated by the internal combustion engine providing compressive capability for fluids.

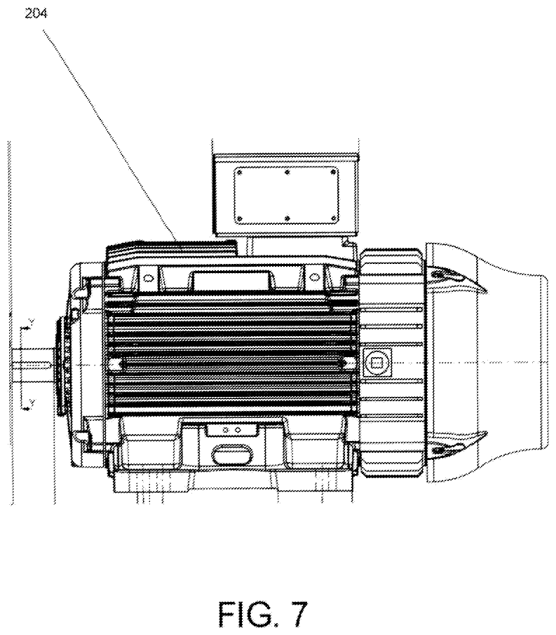

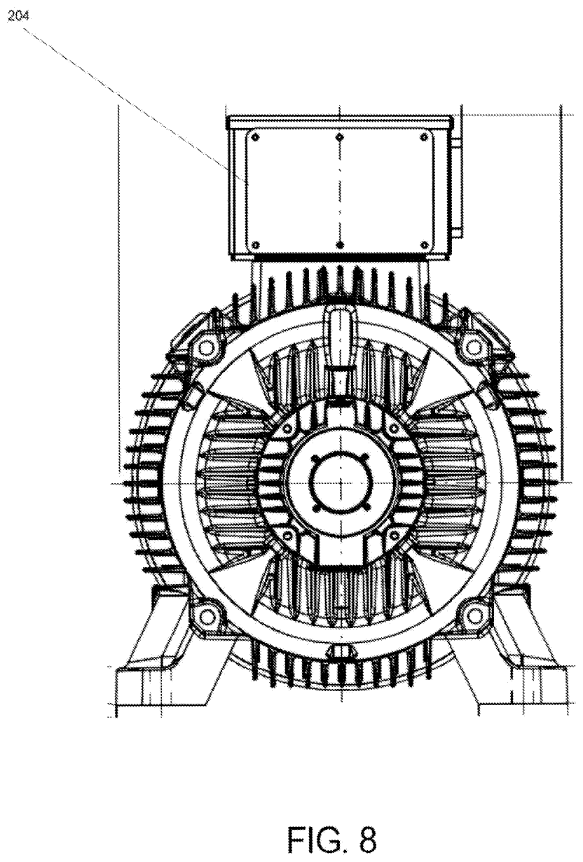

Referring to FIG. 7, a side elevation of a generator 204 used in driving compressor applications is illustrated. Referring to FIG. 8, and end view of the generator 204 of FIG. 7 is illustrated. For FIGS. 7 and 8, the generator 204 may be a three phase 60 Hz unit. In one embodiment, the genitor 204 is sized to drive a 20 horsepower motor. A voltage regulator may be incorporated into the generator 204 or may be an external component. The generator 204 may be a brushless design, in one embodiment, with a rated speed of 1800 rpm with a rated current of 47.07 amps. Rated output may be 37.5 kVA/30.0 kW with a rated voltage of 460V.

Mounting of the generator 204 may be accomplished through a mounting system that attaches to a structural member. In one example embodiment, a two-piece mount is used to anchor the generator 204 inside a plenum. A structural modification kit may be used to fit the generator 204 inside the plenum such that field labor is minimized.

Actuation of the generator 204 may be accomplished through computer control of manual start. A soft-start panel may be provided with electrical protection preventing serious electrical faults from occurring. In one example embodiment, a 50 amp main circuit breaker is provided. A transformer may be provided with the generator 204 with primary and secondary protection. In one example embodiment, the transformer may be a 150 volt transformer. A manual override switch/button may also be provided to allow for operators to disconnect the generator 204 from other components of the system.

The generator 204 may have indicator lights attached to allow for visual identification of status, including “run” conditions. “stop” conditions and “fault” conditions. Reset buttons may be provided to place the generator back into a predefined running condition.

Embodiments of the generator 204 may be placed into an enclosure to allow for protection of the generator 204 from environmental concerns, such as water intrusion. The generator 204 may be provided with shock protection to allow the generator 204 to operate in vibratory conditions. Mounting of the generator 204 may conform to hazardous area conditions, Class 1, Division II capabilities.

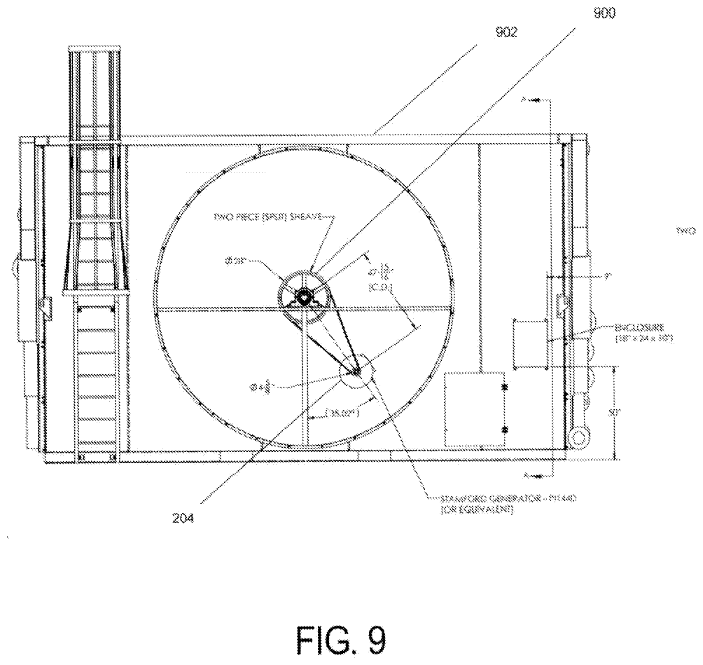

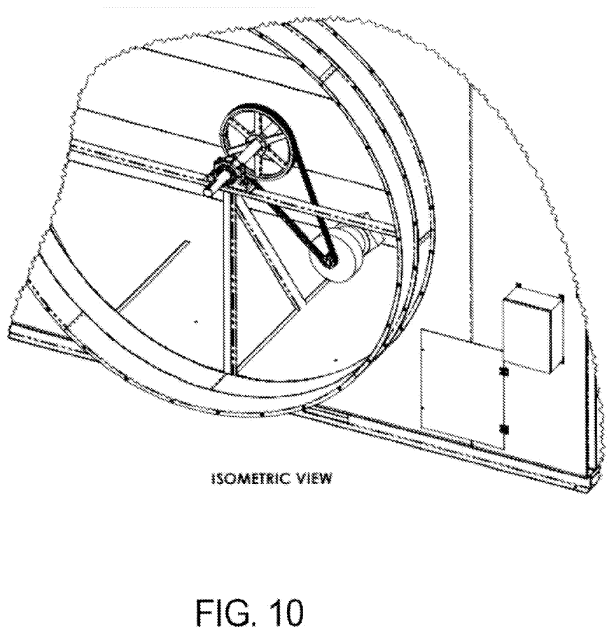

FIG. 9 is a cross-sectional view of the generator 204 in FIG. 7, installed within an enclosure. As illustrated, the generator 204 is connected to the compressor through a split sleeve arrangement 900. Such an installation within the enclosure 902 of the compressor allows for protection of the generator 204 from environmental forces. An isometric view of the installed generator 204 is illustrated in FIG. 10.

In one example embodiment, a method of operating a generator drive system used in compressor applications is disclosed. The method may comprise providing and operating an internal combustion engine coupled to a compressor. The method may also comprise producing electrical power from a generator coupled to the internal combustion engine and operating a variable frequency drive connected to the generator. The method may also provide driving a cooler connected to the variable frequency drive, while the internal combustion engine provides a motive operating force to a fluid compressor.

In another example embodiment, the method may be performed wherein the internal combustion engine is a natural gas driven internal combustion engine.

In another example embodiment, the method may be performed wherein the internal combustion engine is a gasoline powered internal combustion engine.

In another example embodiment, the method may be performed wherein the internal combustion engine is a diesel powered internal combustion engine.

In another example embodiment, the method may further comprise charging a battery storage unit with the produced electrical power from the generator.

In another example embodiment, the method may be performed wherein the variable frequency drive is provided motive force through the battery storage unit.

In another example embodiment, the method may further comprise compressing the fluid with the compressor.

In another example embodiment, the method may be performed wherein the method may be performed wherein the fluid is a gas.

In another example embodiment, the method may be performed wherein the gas one of air, carbon dioxide, nitrogen, natural gas, argon, and hydrogen.

In another embodiment, a method of operating a generator drive system used in compressor applications is disclosed. The method may include providing and operating an internal combustion engine coupled to a compressor, producing electrical power from a generator coupled to the internal combustion engine; and driving a cooler connected to the generator, while the internal combustion engine provides a motive operating force to a fluid compressor.

In another example embodiment, the method may be performed wherein the internal combustion engine is a natural gas driven internal combustion engine.

In another example embodiment, the method may be performed wherein the internal combustion engine is a gasoline powered internal combustion engine.

In another example embodiment, the method may be performed wherein the internal combustion engine is a diesel powered internal combustion engine.

In another example embodiment, the method may further comprise charging a battery storage unit with the produced electrical power from the generator.

In another example embodiment, the method may be performed wherein the cooler is provided motive force through the battery storage unit.

In another example embodiment, the method may further comprise compressing a fluid with the compressor.

In another example embodiment, the method may be performed wherein the fluid is a gas.

In another example embodiment, the method may be performed wherein the gas is one of air, carbon dioxide, nitrogen, natural gas, argon, and hydrogen.

In another example embodiment, a non-transitory computer readable media containing instructions is disclosed wherein the instructions are configured to perform a method comprising operating an internal combustion engine, producing electrical power from a generator coupled to the internal combustion engine, operating a variable frequency drive connected to the generator and driving a cooler connected to the variable frequency drive, while the internal combustion engine provides a motive operating force to a fluid compressor.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

1. A method of operating a generator drive system used in compressor applications, comprising:
operating an internal combustion engine;
producing electrical power from a generator coupled to the internal combustion engine;
operating a variable frequency drive connected to the generator; and
driving a cooler directly connected to the variable frequency drive, wherein a speed of operation of the cooler is not linked to an operating speed of the internal combustion engine.

2. The method according to claim 1, wherein the internal combustion engine is a natural gas driven internal combustion engine.

3. The method according to claim 1, wherein the internal combustion engine is a gasoline powered internal combustion engine.

4. The method according to claim 1, wherein the internal combustion engine is a diesel powered internal combustion engine.

5. The method according to claim 1, further comprising:
charging a battery storage unit with the produced electrical power from the generator.

6. The method according to claim 5, wherein the variable frequency drive is provided motive force through the battery storage unit.

7. The method according to claim 1, further comprising:
compressing the fluid with the compressor.

8. The method according to claim 7, wherein the fluid is a gas.

9. The method according to claim 8, wherein the gas is one of air, carbon dioxide, nitrogen, natural gas, argon, and hydrogen

10. (canceled)

11. (canceled)

12. (canceled)

13. (canceled)

14. (canceled)

15. (canceled)

16. (canceled)

17. (canceled)

18. (canceled)

19. A non-transitory computer readable media containing instructions, wherein the instructions are configured to perform a method comprising instructions comprising:
operating an internal combustion engine;
producing electrical power from a generator coupled to the internal combustion engine;
operating a variable frequency drive connected to the generator; and
driving a cooler directly connected to the variable frequency drive, while the internal combustion engine provides a motive operating force to a fluid compressor, wherein a speed of operation of the cooler is not linked to an operating speed of the internal combustion engine.
